(19) United States
(12) Patent Application Publication
(10) Pub. No.: US 2017/0097995 A1
(43) Pub. Date: Apr. 6, 2017

(54) Video Search Algorithm

(71) Applicant: YAU PING CHAN, Hong Kong (HK)

(72) Inventor: YAU PING CHAN, Hong Kong (HK)

(21) Appl. No.: 14/807,239

(22) Filed: Oct. 5, 2015

(51) Int. Cl. G06F 17/30

(52) U.S. Cl. CPC G06F 17/30843; G06F 17/30828; H04L 67/42

(57) ABSTRACT

AVDOS is a server algorithm and service, which can be utilized by series of API call from the client side. The client will make request to the server by pass the command and proper parameter to initiate the process. Once the server accepts the call, it will start to digest the parameter, a.k.a. the search term(s), which can be text, image, voice or video. It will then compare and provide a ranking for the search term(s). Algorithm will then search through the database of video and choose the most relevant video as the result. These videos will be trimmed and only the highlight will be return as result. This result will be render and compile into a new video and return to the client side.

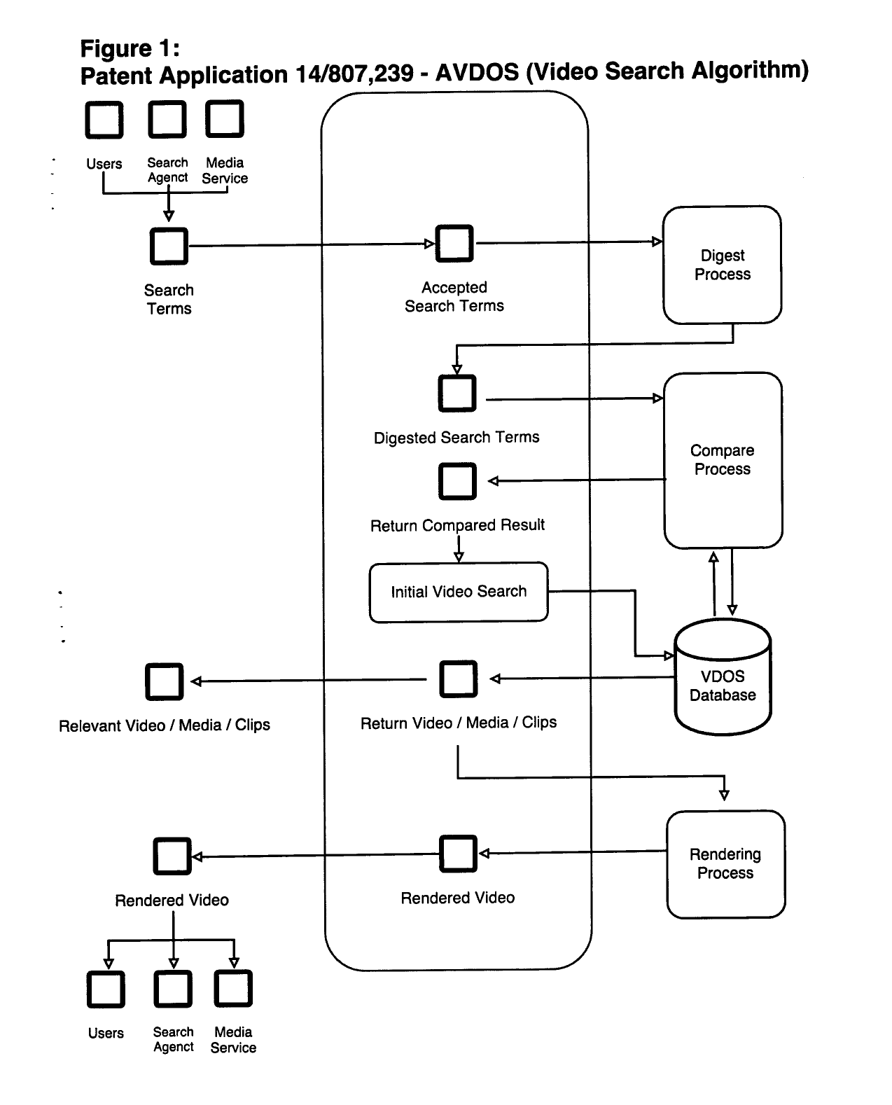

### BRIEF DESCRIPTION OF THE DRAWINGS

### Start of Process

1. User/Search Agent/Media Service can initial the usage of the API

1.1 Search Term(s) can be: Text, Image, Voice or Video

2. Search Terms pass into VDOS-API as a parameter.

3. VDOS-API took the Search Terms and confirm it is valid.

3.1 VDOS will acknowledge user, the terms is accepted.

4. VDOS will pass the accepted terms to a Digest Process

5. Digest Process will categorize the search terms by type (text/image/voice/video

5.1 Digest Process will utilize 3rd parties Algorithm to analyze the search terms

5.2 Digest Process will return: Processed search terms (that match the VDOS ranking system), A ranking category, A ranking score, and A Complete digested search terms

6. Result is passed to our Ranking system

6.1 The Ranking system will compare the result with the VDOS database (VDOS dB)

6.2 The Comparison result is returned to VDOS-API: Index of Video in VDOS dB, Ranking score against each indexed video, and Index of Highlighted segment (of each video)

7. VDOS-API then initiate the communication with VDOS dB

8. VDOS dB return the segment of highlighted videos

8B. The Highlight videos can be returned to User (Optional)

9. The Highlighted segment is passed to The Rendering Process

10. The Rendering Process take various segment of video and render them into a new video

10.1 New video clips is returned

11. VDOS-API will re-package the video and return it to User

The Ranking and dB is updated on each process to allow learning of search term digest.

### End of Process

1. The video search engine digests user search terms; compares the video database to gather the most related video; captures the highlights to render and compile it into a short video, and then returns it to the user for reference, viewing, and further handling.
